(19) United States
(12) Patent Application Publication
(10) Pub. No.: US 2016/0342968 A1
(43) Pub. Date: Nov. 24, 2016

(54) LOYALTY PROGRAM SYSTEM

(71) Applicant: EMPIRE TECHNOLOGY DEVELOPMENT LLC, Wilmington, DE (US)

(72) Inventors: Mordehai MARGALIT, Zichron Yaaqov (IL); Natalya SEGAL, Even Yehuda (IL); Shmuel UR, Galil (IL); Vlad Grigore DABIJA, Mountain View, CA (US)

(21) Appl. No.: 14/761,389

(22) PCT Filed: Dec. 15, 2014
(86) PCT No.: PCT/US14/70414

§ 371 Date: Jul. 16, 2015

(51) Int. Cl. G06Q 20/20; G06Q 30/02

(52) U.S. Cl. CPC G06Q 20/20; G06Q 30/0207

(57) ABSTRACT

Technologies are generally described that relate to managing and/or generating incentive data. An example method may include receiving a set of activity data associated with an entity. The method may also include generating incentive data for the entity based on a determination that an activity selected from the set of activity data is to be performed with respect to a target object and satisfies a rule of a set of rules associated with the target object, where the generating the incentive data is independent of a point of sale purchase of the target object.

### TECHNICAL FIELD

The subject disclosure relates generally to managing and/or generating incentives associated with products, services and/or goods.

### BACKGROUND

Existing loyalty program systems (e.g., reward program systems, etc.) can provide rewards to consumers that purchase a product or good. For example, a coffee vendor can provide a mobile application that can be downloaded to a mobile device of a customer. The mobile application on the mobile device can then be employed by the customer to keep track of rewards points (e.g., reward stars, etc.) associated with purchased products or goods at the coffee vendor. For example, each time a customer purchases a product or good at the coffee vendor, the mobile device that includes the mobile application can be scanned (e.g., a quick response code displayed on the mobile device can be scanned) and the customer (e.g., a registered account of the customer) can earn a reward point. A registered account of the customer can be managed and/or maintained by the mobile application of the mobile device. After the customer (e.g., the registered account of the customer) is associated with a particular number of reward points, the customer (e.g., the registered account of the customer) can be rewarded a free drink or a discount for a future purchase.

However, existing loyalty program systems often require a customer to actively scan the mobile device (e.g., scan the quick response code displayed on the mobile device) for each purchase. Also, vendors (e.g., smaller vendors, etc.) often times do not offer and/or participate in a loyalty program (e.g., a rewards program, etc.). Furthermore, a product or good produced by a particular company is often times offered at multiple vendors that are not owned by and/or associated with the particular company. Moreover, a consumer of a product or good may not be the purchaser of the product or good.

### SUMMARY

In various, non-limiting embodiments, systems, devices, methods and/or computer-readable storage media that facilitate entity presence of purchases are described herein.

In some embodiments, a method may include receiving a set of activity data associated with an entity, and generating incentive data for the entity based on a determination that an activity selected from the set of activity data is to be performed with respect to a target object and satisfies a rule of a set of rules associated with the target object, where the generating the incentive data is independent of a point of sale purchase of the target object.

In another embodiment, a system includes an activity recognition component, a product recognition component, an evaluation component and an inducement component. The activity recognition component collects a set of activity information associated with an entity. The product recognition component evaluates the set of activity information for a target object. The evaluation component determines an activity of the set of activity information that conforms to a rule of a set of rules defined for the target object. The inducement component provides incentive information indicative of an incentive associated with the target object based on the activity determined by the evaluation component.

In yet another embodiment, a computer-readable storage device stores executable instructions that, in response to execution, cause a device including a processor to perform operations. The operations include: receiving a set of activity data associated with an entity, determining whether an activity of the set of activity data is performed with respect to a target object and satisfies a rule of a set of rules defined for the target object, and generating incentive data for consumption by the entity, where the generating the incentive data occurs outside of a context of a point of sale purchase of the target object.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, various non-limiting embodiments are further described with reference to the accompanying drawings in which:

FIG. 1 illustrates an example, non-limiting embodiment of a method to manage and/or generate incentive data;

FIG. 2 illustrates an example, non-limiting embodiment of a system to manage and/or generate incentive data;

FIG. 3 illustrates an example, non-limiting embodiment of another system to manage and/or generate incentive data;

FIG. 4 illustrates an example, non-limiting embodiment of a system to employ a device to manage and/or generate incentive data independent of a point of sale purchase;

FIG. 5 illustrates an example, non-limiting embodiment of a system to employ a device and at least one server to manage and/or generate incentive data independent of a point of sale purchase;

FIGS. 6-9 illustrate example, non-limiting embodiments of other methods to manage and/or generate incentive data;

FIG. 10 illustrates a flow diagram of an example, non-limiting embodiment of a set of operations to manage and/or generate incentive data; and

FIG. 11 illustrates an example block diagram of a computing device that is arranged to manage and/or generate incentive data in accordance with one or more embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, may be arranged, substituted, combined, separated, and designed in a wide variety of different configurations, all of which are explicitly contemplated herein.

Existing loyalty program systems (e.g., reward program systems, etc.) can provide rewards to consumers that purchase a product or good. For example, a coffee vendor can provide a mobile application that can be downloaded to a mobile device of a customer. The mobile application on the mobile device can then be employed by the customer to keep track of rewards points (e.g., reward stars, etc.) associated with purchased products or goods at the coffee vendor. For example, each time a customer purchases a product or good at the coffee vendor, the mobile device that includes the mobile application can be scanned (e.g., a quick response code displayed on the mobile device can be scanned) and the customer (e.g., a registered account of the customer) can earn a reward point. A registered account of the customer can be managed and/or maintained by the mobile application of the mobile device. After the customer (e.g., the registered account of the customer) is associated with a particular number of reward points, the customer (e.g., the registered account of the customer) can be rewarded a free drink or a discount for a future purchase. However, conventional user devices (e.g., mobile devices) are not able to determine and/or record transactions associated with a product or good. Existing loyalty program systems often require a customer to actively scan the mobile device (e.g., scan the quick response code displayed on the mobile device) for each purchase. Also, vendors (e.g., smaller vendors, etc.) often times do not offer and/or participate in a loyalty program (e.g., a rewards program, etc.). Furthermore, a product or good produced by a particular company is often times offered at multiple vendors that are not owned by and/or associated with the particular company. Moreover, a consumer of a product or good may not be the purchaser of the product or good.

To address these and other issues, one or more embodiments of the present disclosure facilitate an improved loyalty program system (e.g., improved reward program system, etc.). In various embodiments described herein, activity information associated with an entity (e.g., a customer, a consumer, a user, etc.) can be captured and/or collected via a device (e.g., a smartphone, a wearable computing device, a tablet, another type of computing device, etc.). The activity information can be captured by the device and/or can be provided to the device (e.g., via user input). The device can evaluate the activity information to facilitate identifying a product, good or service associated with an activity of the entity. Additionally, the device or another device can determine whether an activity associated with the activity information conforms to a rule defined for the product, good or service. A rule can be associated with consumption, a purchase and/or a recommendation with regard to the product, good or service. Additionally, a rule can be associated with a verbal reference, a visual reference, a location, metadata and/or other data related to the product, good or service. In response to a determination that the activity conforms to the rule defined for the product, good or service (e.g., in response to a validation of the activity), incentive information (e.g., a reward, a discount, a coupon, etc.) for consumption by the entity can be generated. The incentive information can be generated outside of a context of a point of sale purchase of the product, good or service. Accordingly, consumption of the product, good or service can be rewarded regardless of a location and/or involvement of a vendor associated with a point of sale purchase of the product, good or service. Moreover, consumption of the product, good or service can also be rewarded regardless of whether the entity that consumed the product, good or service purchased the product, good or service.

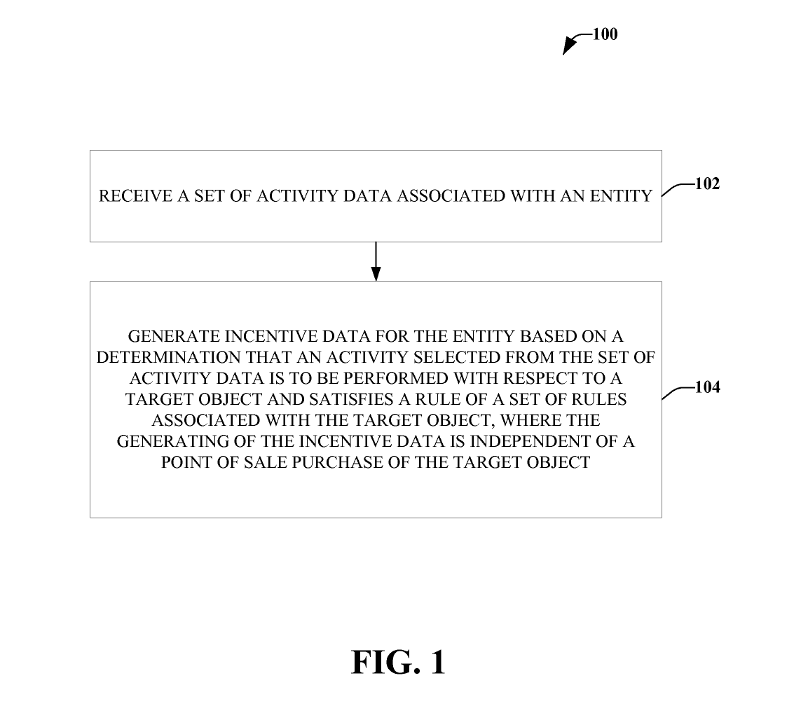

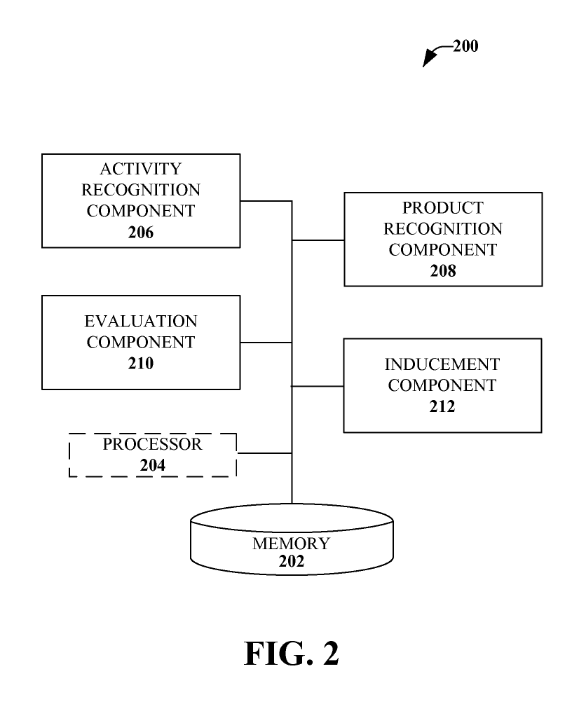

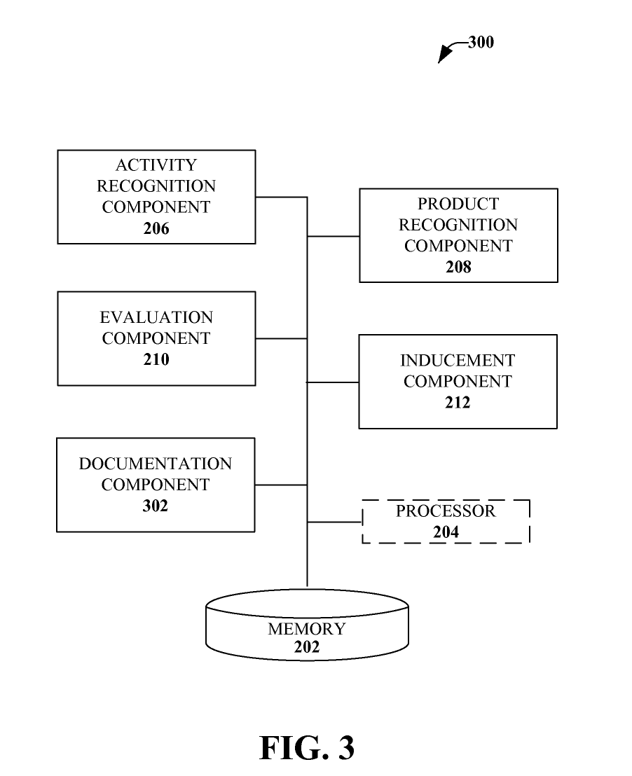

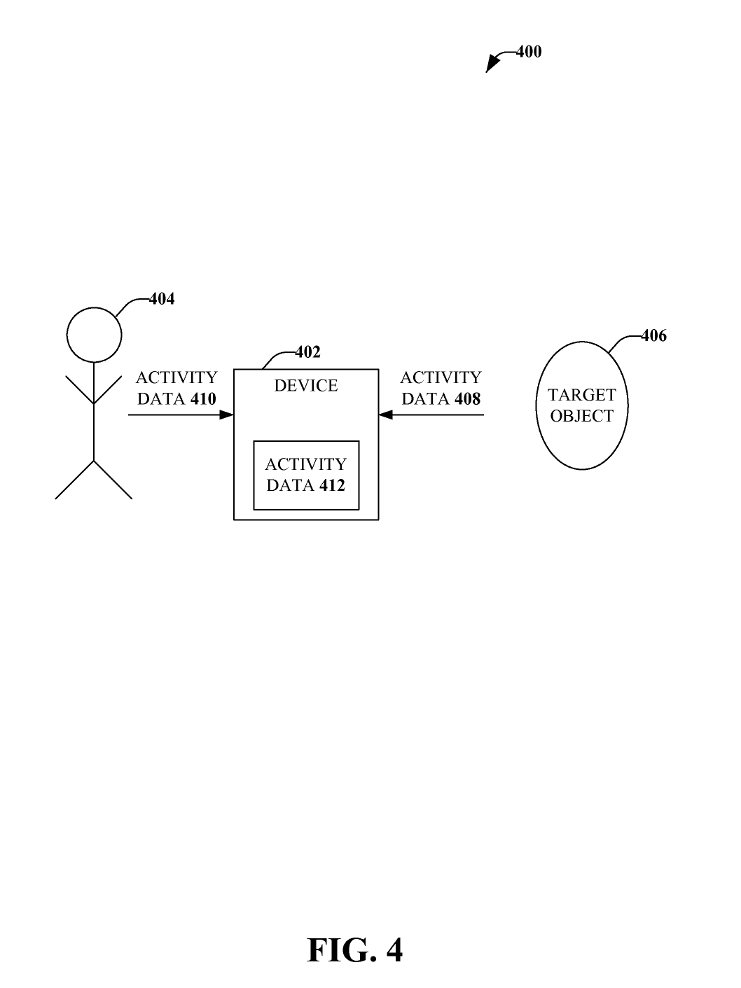

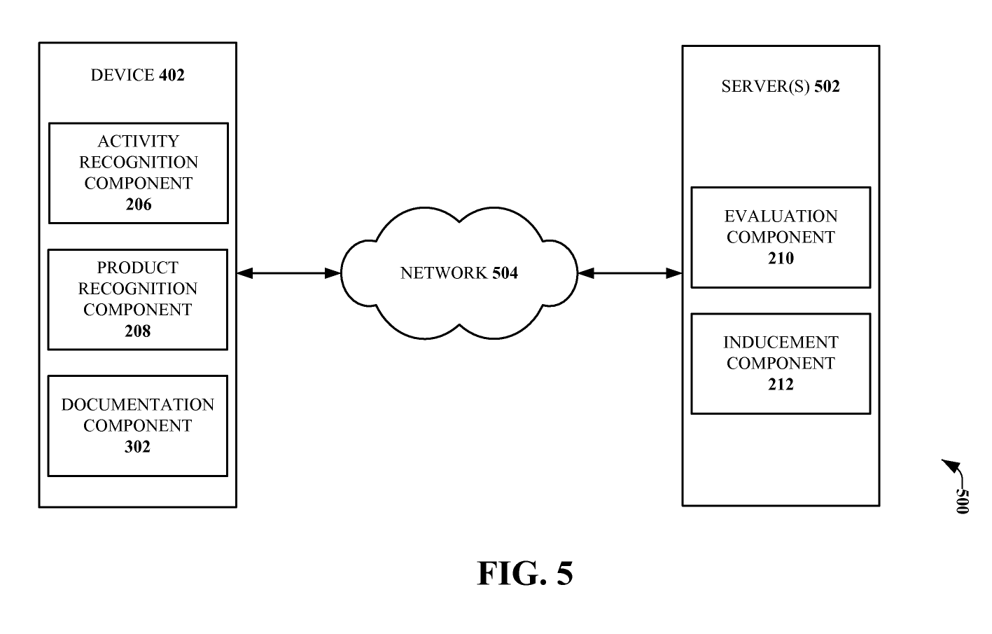

FIG. 1 illustrates an example, non-limiting embodiment of a method 100 to manage and/or generate incentive data (e.g., incentive data associated with a loyalty program). In an aspect, the method 100 can be associated with a loyalty program system (e.g., a rewards program system). The method 100 in FIG. 1 can be implemented using, for example, any of the systems, such as a system 200 (of FIG. 2), a system 300 (of FIG. 3), a system 400 (of FIG. 4), a system 500 (of FIG. 5), etc., described herein below. The method 100 may include one or more operations, functions or actions as illustrated by one or more of blocks 102 and/or 104.

Beginning at block 102, a set of activity data associated with an entity is received. An entity can be, for example, a user (e.g., a consumer, a customer, etc.) and/or a user identity (e.g., a consumer identity, a customer identity, an account, etc.). The set of activity data can be associated with, but is not limited to, audio data, visual data, sensor data, input data (e.g., user input data, etc.), location data and/or other data. In an aspect, the set of activity data can be captured by and/or associated with a device (e.g., a device associated with the entity). The device associated with the entity can be a computing device, such as but not limited to, a phone, a smartphone, a wearable computing device (e.g., a wearable computer, which may be embodied on glasses, for example), a tablet, a computer, a laptop computer, an eReader, a netbook, a gaming console or device, another type of computing device, etc. Furthermore, the set of activity data can be associated with a set of actions determined to have been performed by the entity. For example, the set of actions can be determined to have been performed by the entity based on the set of activity data.

The set of activity data associated with the entity (e.g., a set of activities) can be recorded prior to receiving the set of activity data and/or after receiving the set of activity data (e.g., by the device associated with the entity and/or another device). For example, audio data, visual data, sensor data, input data, location data and/or other data associated with the entity and/or the device associated with the entity can be recorded. In an embodiment, an instruction to record the set of activity data can be transmitted (e.g., to initiate recording of the set of activity data) to the device associated with the entity. The set of activity data can be recognized based on one or more augmented reality processing techniques, one or more image processing techniques, one or more audio processing techniques and/or one or more other techniques. In one example, the set of activity data can be recognized by augmenting a scene viewed by the entity with a virtual scene generated by the device associated with the entity. Block 102 may be followed by block 104.

At block 104, incentive data for the entity is generated based on a determination that an activity selected from the set of activity data is to be performed with respect to a target object and satisfies a rule of a set of rules associated with the target object, where the generating of the incentive data is independent of a point of sale purchase of the target object. A target object can include, but is not limited to, a product, a good, a service, an item of manufacture, a location, etc. A target object can also be associated with a product provider, a service provider, a merchant, a vendor, a company, a corporation, a business, a manufacturer, a retailer, a store, an online store, etc. A rule (e.g., a set of rules) can be associated with consumption of the target object, purchase of the target object, recommendation of the target object and/or another interaction with the target object. Additionally, a rule can be associated with a verbal reference related to the target object, a visual reference related to the target object, a location related to the target object, metadata related to the target object, other data related to the target object, etc. Incentive data can be an incentive (e.g., a reward, a discount, etc.) applicable for use (e.g., consumption, etc.) by the entity. The incentive data can be associated with the target object and/or another target object related to the target object. Additionally or alternatively, the incentive data can be associated with a provider of the incentive (e.g., a product provider, a service provider, a merchant, a vendor, a company, a corporation, a business, a manufacturer, a retailer, a store, an online store, etc.).

According to some implementations, the set of activity data associated with the entity can be filtered prior to recording the set of activity data and/or after recording the set of activity data (e.g., by the device associated with the entity and/or another device). For example, activity data related to a set of actions associated with the entity with respect to the target object can be determined and/or recorded (e.g., a set of actions determined to have been performed by the entity with respect to the target object can be recorded). Therefore, audio data, visual data, sensor data, input data, location data and/or other data that is associated with the target object (e.g., that identifies the target object, etc.) can be recorded. Data that identifies the target object (e.g., audio data, visual data, sensor data, input data, location data and/or other data) can include a specific identification of the target object. In another example, the set of actions determined to have been performed by the entity can be a filtered subset of the set of activity data that is not associated with another entity. For example, a set of actions determined to have been performed by the entity can be distinguished from another set of actions determined to have been performed by another entity. In yet another example, the set of activity data can be monitored for at least one activity (e.g., a set of activities) that is related to the target object and/or that the entity has been determined to have participated.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

Turning now to FIG. 2, illustrated is an example, non-limiting embodiment of the system 200 to manage and/or generate incentive data (e.g., incentive data associated with a loyalty program). In one example, the system 200 can be associated with a loyalty program system (e.g., a rewards program system). The system 200 can include at least one memory 202 that can store computer-executable components and instructions. The system 200 can also include at least one processor 204, communicatively coupled to the at least one memory 202. Coupling can include various communications including, but not limited to, direct communications, indirect communications, wired communications, and/or wireless communications. The at least one processor 204 can be operable to execute or facilitate execution of one or more of the computer-executable components stored in the memory 202. The processor 204 can be directly involved in the execution of the computer-executable component(s), according to an aspect. Additionally or alternatively, the processor 204 can be indirectly involved in the execution of the computer executable component(s). For example, the processor 204 can direct one or more components to perform the operations.

It is noted that although one or more computer-executable components can be described herein and illustrated as components separate from the memory 202 (e.g., operatively connected to memory), in accordance with various embodiments, the one or more computer-executable components might be stored in the memory 202. Further, while various components have been illustrated as separate components, it will be appreciated that multiple components can be implemented as a single component, or a single component can be implemented as multiple components, without departing from example embodiments.

The system 200 can also include an activity recognition component 206, a product recognition component 208, an evaluation component 210 (e.g., an evaluation manager) and/or an inducement component 212 (e.g., an inducement manager). The system 200 can be implemented on a device associated with an entity and/or another device (e.g., at least one server). A device associated with an entity can be a computing device, such as but not limited to, a phone, a smartphone, a wearable computing device (e.g., a wearable computer, which may be embodied on glasses, for example), a tablet, a computer, a laptop computer, an eReader, a netbook, a gaming console or device, another type of computing device, etc.

The activity recognition component 206 can collect and/or determine a set of activity information (e.g., activity data) associated with an entity. The activity recognition component 206 can collect and/or determine the set of activity information via one or more devices of the device associated with the entity. For example, the activity recognition component 206 can collect and/or determine the set of activity information via one or more cameras, one or more microphones, one or more 3D imaging systems (e.g., light field sensor(s), motion sensor(s), etc.), one or more sensory devices and/or one or more other devices of the device associated with the entity. The activity recognition component 206 can collect audio information, visual information, sensor information, input information (e.g., information that is input to the device associated with the entity), location information and/or other information associated with the entity and/or the device associated with the entity. In an aspect, the activity recognition component 206 can determine a set of actions performed by the entity to facilitate collecting the set of activity information. The activity recognition component 206 can also record the set of activity information (e.g., store the set of activity information). In certain implementations, the activity recognition component 206 can additionally or alternatively filter the set of activity information. In an aspect, the activity recognition component 206 can receive an instruction (e.g., from at least one server) to record and/or filter the set of activity data.

The product recognition component 208 can evaluate the set of activity information for a target object. For example, the product recognition component 208 can evaluate the set of activity information collected and/or determined by the activity recognition component 206, such as but not limited to, audio information, visual information, sensor information, input information (e.g., information that is input to the device associated with the entity), location information and/or other information associated with the entity and/or the device associated with the entity for a target object. The product recognition component 208 can employ one or more augmented reality techniques, one or more image processing and/or recognition techniques, one or more facial recognition techniques, one or more audio processing and/or recognition techniques, and/or one or more other techniques to evaluate the set of activity information for a target object. Based on the evaluation of a set of activity information for a target object, the product recognition component 208 can identify the target object. In a non-limiting example, the product recognition component 208 can identify the target object by evaluating an image (e.g., a picture) including the target object and/or audio including a word or phrase associated with the target object.

The evaluation component 210 can determine (e.g., identify) an activity of the set of activity information that conforms to a rule of a set of rules defined for the target object. For example, the evaluation component 210 can evaluate the set of activity information collected and/or determined by the activity recognition component 206, such as but not limited to, audio information, visual information, sensor information, input information (e.g., information that is input to the device associated with the entity), location information and/or other information associated with the entity and/or the device associated with the entity to determine whether an activity of the set of activity information conforms to a rule of a set of rules defined for the target object. A rule (e.g., a set of rules) can be associated with consumption of the target object, purchase of the target object, recommendation of the target object and/or another interaction with the target object. Additionally, a rule can be associated with a verbal reference related to the target object, a visual reference related to the target object, a location related to the target object, metadata related to the target object, other data related to the target object, etc. It is to be appreciated that one or more rules can be defined for a target object. The evaluation component 210 can employ one or more augmented reality techniques, one or more image processing and/or recognition techniques, one or more facial recognition techniques, one or more audio processing and/or recognition techniques, and/or one or more other techniques to determine an activity of the set of activity information that conforms to a rule of a set of rules defined for the target object. In a non-limiting example, the product recognition component 208 can identify an activity that conforms to a rule defined for the target object by evaluating an image (e.g., a picture) associated with the activity and/or audio associated with the activity.

The various aspects (e.g., in connection with evaluating activity information) may employ various artificial intelligence-based schemes for carrying out various aspects thereof. For example, a process for evaluating the set of activity information for a target object and/or a process for determining an activity of the set of activity information that conforms to a rule of a set of rules defined for the target object may be enabled through an automatic classifier system and process. A classifier is a function that maps an input attribute vector, x=(x1, x2, x3, x4, xn), to a confidence that the input belongs to a class, that is, f(x)=confidence(class). Such classification may employ a probabilistic and/or statistical-based analysis (e.g., factoring into the analysis utilities and costs) to prognose or infer an action that a user desires to be automatically performed.

A support vector machine (SVM) is an example of a classifier that may be employed. The SVM operates by finding a hypersurface in the space of possible inputs, which hypersurface attempts to split the triggering criteria from the non-triggering events. Other directed and undirected model classification approaches include, for example, naïve Bayes, Bayesian networks, decision trees, neural networks, fuzzy logic models, and probabilistic classification models providing different patterns of independence may be employed. Classification as used herein also is inclusive of statistical regression that is utilized to develop models of priority. The one or more aspects may employ classifiers that are explicitly trained (e.g., through a generic training data) as well as implicitly trained (e.g., by observing user behavior, receiving extrinsic information). For example, SVM's are configured through a learning or training phase within a classifier constructor and feature selection module. Thus, the classifier(s) may be used to learn and perform a number of functions as described herein.

The inducement component 212 can provide (e.g., make available) incentive information indicative of an incentive associated with the target object based on the activity determined by the evaluation component 210. Incentive information can be an incentive (e.g., a reward, a discount, etc.) applicable for use (e.g., consumption, etc.) by the entity. The incentive information can be associated with the target object and/or another target object related to the target object. Additionally or alternatively, the incentive data can be associated with a provider of the incentive (e.g., a product provider, a service provider, a merchant, a vendor, a company, a corporation, a business, a manufacturer, a retailer, a store, an online store, etc.). In an aspect, the inducement component 212 can provide reward information that represents a reward based on a determination that an accumulation of a set of incentives that includes the incentive satisfies a defined amount of activities performed by the entity with respect to the target object. For example, incentive information can include a total number (e.g., a count, a tally, etc.) of activities that conforms to a rule of a set of rules defined for the target object. In another aspect, the inducement component 212 can send (e.g., transmit) reward information to another device. In yet another aspect, the evaluation component 210 can determine another activity of the set of activity information that conforms to another rule of the set of rules defined for the target object. The inducement component 212 can therefore provide other incentive information indicative of another incentive associated with the target object.

Turning to FIG. 3, illustrated is an example, non-limiting embodiment of the system 300 to manage and/or generate incentive data (e.g., incentive data associated with a loyalty program). In one example, the system 300 can be associated with a loyalty program system (e.g., a rewards program system). The system 300 can include the memory 202, the processor 204, the activity recognition component 206, the product recognition component 208, the evaluation component 210, the inducement component 212 and/or a documentation component 302 (e.g., a documentation manager).

The documentation component 302 can capture the activity that conforms to the rule at substantially a same time as the activity is performed by the entity and/or another entity. For example, the documentation component 302 can record data associated with consumption of the target object at substantially a same time as the consumption occurs, the documentation component 302 can record data associated with purchase of the target object at substantially a same time as the purchase occurs, the documentation component 302 can record data associated with recommendation of the target object at substantially a same time as the recommendation occurs, the documentation component 302 can record data related another interaction with the target object at substantially a same time as the interaction occurs, etc. In one example, the documentation component 302 can record audio information indicative of a verbal reference to the target object by the entity and/or another entity. In another example, the documentation component 302 can record visual information indicative of the target object. In yet another example, the documentation component 302 can record location information indicative of a location associated with the target object. However, it is to be appreciated that the documentation component 302 can record other information associated with the target object and/or an activity.

Turning now to FIG. 4, illustrated is an example, non-limiting embodiment of the system 400 to manage and/or generate incentive data independent of a point of sale purchase. The system 400 can include a device 402. The device 402 can be associated with a user 404 (e.g., an entity 404, a consumer 404, a customer 404, etc.) and/or a user identity (e.g., a consumer identity, a customer identity, a profile, an account, etc.). The device 402 can be a computing device, such as but not limited to, a phone, a smartphone, a wearable computing device (e.g., a wearable computer, which may be embodied on glasses, for example), a tablet, a computer, a laptop computer, an eReader, a netbook, a gaming console or device, another type of computing device, etc. Accordingly, the user 404 can utilize and/or wear the device 402.

The device 402 can be configured to determine and/or generate incentive data associated with a target object 406. The target object 406 can be a product, a good, a service, an item of manufacture, a location, etc. The target object 406 can also be associated with a product provider, a service provider, a merchant, a vendor, a company, a corporation, a business, a manufacturer, a retailer, a store, an online store, etc. The device 402 can include at least the memory 202, the processor 204, the activity recognition component 206 and/or the product recognition component 208. In an implementation, the device 402 can also include the evaluation component 210, the inducement component 212 and/or the documentation component 302. Alternatively, the evaluation component 210 and/or the inducement component 212 can be implemented on another device (e.g., a server in communication with the device 402 via a network). For example, an application (e.g., a mobile application, an electronic application, etc.) implemented on (e.g., stored on, downloaded to, etc.) the device 402 can include and/or be associated with the activity recognition component 206, the product recognition component 208, the evaluation component 210, the inducement component 212 and/or the documentation component 302. The device 402 can be configured for communicating over one or more wireless networks and/or one or more wired networks, including but not limited to, a cellular network, a wide area network (WAN, e.g., the Internet), a local area network (LAN) and/or a personal area network (PAN). As such, the device 402 can communicate with other device(s) via virtually any desired wireless or wired technology, including, for example, cellular, WAN, WiFi, etc.

The device 402 can be associated with at least augmented reality functionality (e.g., an augmented reality application, etc.), image recognition functionality and/or audio recognition functionality. Furthermore, the device 402 can include one or more sensory devices, such as but not limited to, one or more cameras, one or more microphones, one or more 3D imaging systems (e.g., light field sensor(s), motion sensor(s), etc.) and/or other sensory devices. The device 402 can collect activity data 408 (e.g., activity information) via the one or more sensory devices of the device 402. For example, the device 402 (e.g., the activity recognition component 206) can collect audio data, visual data, sensor data and/or other data. The activity data 408 collected by the one or more sensor devices of the device 402 can be received by the activity recognition component 206 of the device 402. Additionally or alternatively, the device 402 (e.g., the activity recognition component 206) can receive activity data 410 (e.g., activity information) from the user 404. For example, the user 404 can input data associated with the target object 406 into the device 402. Additionally or alternatively, the device 402 can include activity data 412 (e.g., activity information), which can, for example, be employed by the activity recognition component 206. For example, the device 402 can include location data (e.g., Internet Protocol (IP) geo-location data, etc.) associated with the device 402, metadata associated with the device 402, and/or other data associated with the device 402. Accordingly, collection of information associated with the target object 406, the device 402 and/or the user 404 (e.g., a surrounding area associated with the user 404) can be automatic and/or user-assisted. It is to be appreciated that the user 404 can select and/or provide rights associated with capturing and/or collecting the activity data 408, the activity data 410 and/or the activity data 412 (e.g., capturing information using the device 402 and/or collecting information associated with the device 402).

In an aspect, the device 402 can evaluate the activity data 408, the activity data 410 and/or the activity data 412 via the product recognition component 208. Based on the activity data 408, the activity data 410 and/or the activity data 412, the device 402 (e.g., the product recognition component 208) can generate (e.g., determine) a virtual scene nearby (e.g., surrounding) the device 402. The device 402 (e.g., the product recognition component 208) can also augment a scene viewed by the entity with a virtual scene generated by the device 402. Accordingly, the device 402 (e.g., the product recognition component 208) can identify the target object 406. The evaluation component 210 can determine (e.g., identify) an activity associated with the activity data 408, the activity data 410 and/or the activity data 412 that conforms to a rule of a set of rules defined for the target object 406. For example, the evaluation component 210 can determine whether an activity associated with the activity data 408, the activity data 410 and/or the activity data 412 conforms to a rule of a set of rules defined for the target object 406. A rule of a set of rules defined for the target object 406 can be associated with, for example, consumption of the target object 406, purchase of the target object 406, recommendation of the target object 406 and/or another interaction with the target object 406. In one example, a rule of a set of rules defined for the target object 406 can be determined by a provider of the target object 406 (e.g., a product provider, a service provider, a merchant, a vendor, a company, a corporation, a business, a manufacturer, a retailer, a store, an online store, etc.). The inducement component 212 can provide incentive data indicative of an incentive associated with the target object 406 based on the activity determined by the evaluation component 210.

Accordingly, the activity data 408, the activity data 410 and/or the activity data 412 can be collected and/or employed to determine an interaction of the user 404 (e.g., via the device 402 associated with the user 404) with a target object 406. Furthermore, the user 404 can be rewarded based on an interaction with the target object 406. An interaction with the target object 406 (e.g., an activity, an action, etc.) can include, but not limited to, buying the target object 406, consuming the target object 406, using the target object 406, getting others to consume the target object 406, etc. The device 402 an identify the interaction with the target object 406 based on the activity data 408, the activity data 410 and/or the activity data 412. Collection of information associated with the interaction with the target object 406 (e.g., collection of the activity data 408 and/or the activity data 412) can be automatic. Additionally or alternatively, collection of information associated with the interaction with the target object 406 (e.g., collection of the activity data 410) can be user-assisted. In one example, the user 404 can record an interaction with the target object 406 on the device 402 and/or can identify a type of action performed in associated with the target object 406 (e.g., purchased the target object 406, consumed the target object 406, recommended the target object 406, etc.).

In a non-limiting example, a target object can be a soft drink (e.g., a particular brand of soft drink called “soft drink A”). The device 402 can include and/or be associated with an application (e.g., a mobile application, an electronic application, etc.) provided by and/or associated with a company that produces the soft drink A. The application can include and/or be associated with the activity recognition component 206, the product recognition component 208, the evaluation component 210, the inducement component 212 and/or the documentation component 302. Therefore, each time the user 404 drinks the soft drink A, buys the soft drink A, gives the soft drink A, recommends the soft drink A, etc. (e.g., determined by the application included on the device 402), the action can be recorded by the application. Furthermore, the application included on the device 402 can also generate incentive data (e.g., loyalty points, rewards, discounts, prizes, coupons, etc.) based on the actions associated with the soft drink A. Incentive data can be generated independent of a point of sale purchase of the soft drink A by the user 404. In one example, the user 404 can purchase the soft drink A using cash from a store and still be provided incentive data. In another example, the user 404 can purchase the soft drink A from a street vendor that is not connect to a communication network and still be provided incentive data. In yet another example, the user 404 can select the soft drink A from a refrigerator of at a party and still be provided incentive data. In yet another example, the user 404 can order the soft drink A at a restaurant as a fountain drink and still be provided incentive data. In yet another example, the user 404 can give the soft drink A to a guest at party and still be provided incentive data. Accordingly, a company that produces the soft drink A can influence choices of a consumer with respect to consuming the soft drink A no matter where the consumer is located. For example, a company that produces the soft drink A can persuade a consumer to prefer the soft drink A when at a store, to prefer the soft drink A when visiting a friend, to prefer the soft drink A when buying from a street vendor, etc. Moreover, the company that produces the soft drink A is able to create loyalty to the soft drink A brand regardless of where the soft drink A is consumed and/or whether a consumer scans a quick response code on a mobile device when purchasing the soft drink A.

Turning now to FIG. 5, illustrated is an example, non-limiting embodiment of the system 500 to manage and/or generate incentive data independent of a point of sale purchase. The system 500 can include the device 402 and at least one server 502. In a non-limiting embodiment, the device 402 can include the activity recognition component 206, the product recognition component 208 and/or the documentation component 302. The at least one server 502 can include the evaluation component 210 and/or the inducement component 212. The device 402 can be communicably coupled to the at least one server 502 via a network 504. The network 504 can include one or more networks. For example, network 504 can include one or more wireless networks and/or one or more wired networks, including but not limited to, a cellular network, a wide area network (WAN, e.g., the Internet), a local area network (LAN) and/or a personal area network (PAN). As such, the device 402 can communicate with the at least one server 502 via virtually any desired wireless or wired technology, including, for example, cellular, WAN, WiFi, etc.

In an example, the device 402 (e.g., the activity recognition component 206, the product recognition component 208 and/or the documentation component 302) can transmit (e.g., send) data (e.g., activity data, data associated with a target object (e.g., the target object 406), other data, etc.) to the at least one server 502 (e.g., the evaluation component 210 and/or the inducement component 212) via the network 504. Furthermore, the device 402 can receive data (e.g., incentive data, reward data, other data, etc.) from the at least one server 502 (e.g., the evaluation component 210 and/or the inducement component 212). In an aspect, the at least one server 502 (e.g., the inducement component 212) can send reward data representing a reward to the device 402 based on a determination that an accumulation of incentive data satisfies a defined amount of activities performed by an entity associated with the device 402 with respect to a target object. In another aspect, the at least one server 502 can store information associated with a target object (e.g., the target object 406), the device 402, and/or an entity (e.g., the user 404) associated with the device 402. Information stored by the at least one server 502 can include, but is not limited to, a set of rules defined for a target object, incentive data for consumption by an entity, activity data, reward data, other data, etc.

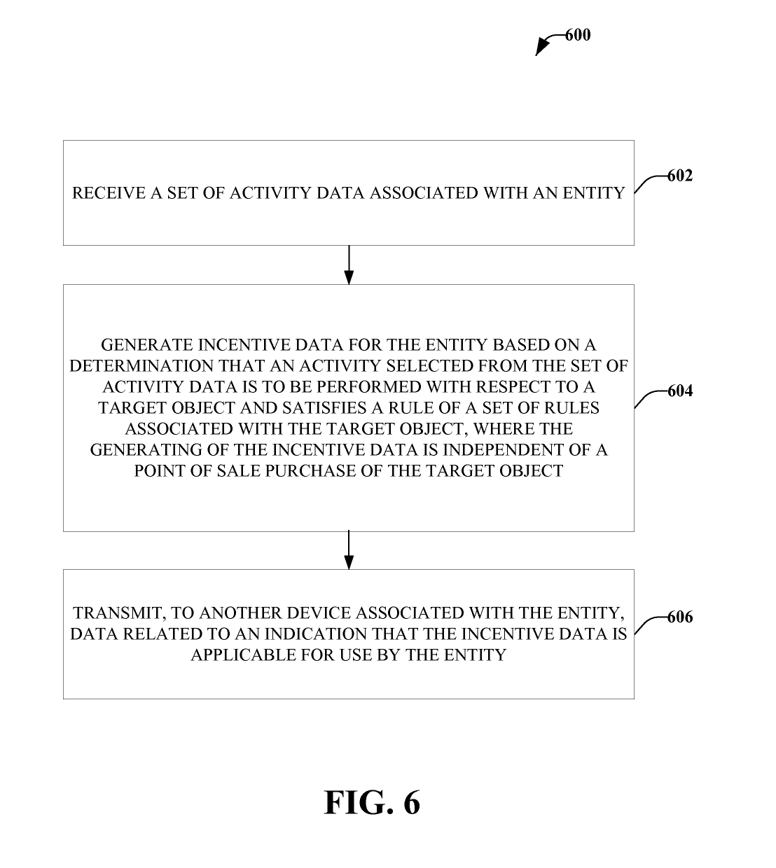

FIG. 6 is a flow diagram illustrating an example, non-limiting embodiment of a method 600 to manage and/or generate incentive data. In an aspect, the method 600 can be associated with a loyalty program system (e.g., a rewards program system). The method 600 in FIG. 6 can be implemented using, for example, any of the systems, such as the system 200 (of FIG. 2), the system 300 (of FIG. 3), the system 400 (of FIG. 4), the system 500 (of FIG. 5), etc., described herein. The method 600 may include one or more operations, functions or actions as illustrated by one or more of blocks 602, 604 and/or 606. In one embodiment, the method 600 can be associated with at least one server (e.g., at least one server 502).

Beginning at block 602, a set of activity data associated with an entity is received. Block 602 may be followed by block 604. At block 604, incentive data for the entity is generated based on a determination that an activity selected from the set of activity data is to be performed with respect to a target object and satisfies a rule of a set of rules associated with the target object, where the generating of the incentive data is independent of a point of sale purchase of the target object. Block 604 may be followed by block 606.

At block 606, data related to an indication that the incentive data is applicable for use by the entity is transmitted to another device associated with the entity. For example, data related to an indication that the incentive data is applicable for use by the entity can be transmitted to a device associated with the entity. In one example, the indication can be a message transmitted to the device associated with the entity. In another example, the indication can be a notification displayed on the device associated with the entity and/or a notification associated with an application installed on the device associated with the entity. Incentive data can be an incentive (e.g., a reward, a discount, etc.) applicable for use (e.g., consumption, etc.) by the entity. The incentive data can be associated with the target object and/or another target object related to the target object. Additionally or alternatively, the incentive data can be associated with a provider of the incentive (e.g., a product provider, a service provider, a merchant, a vendor, a company, a corporation, a business, a manufacturer, a retailer, a store, an online store, etc.).

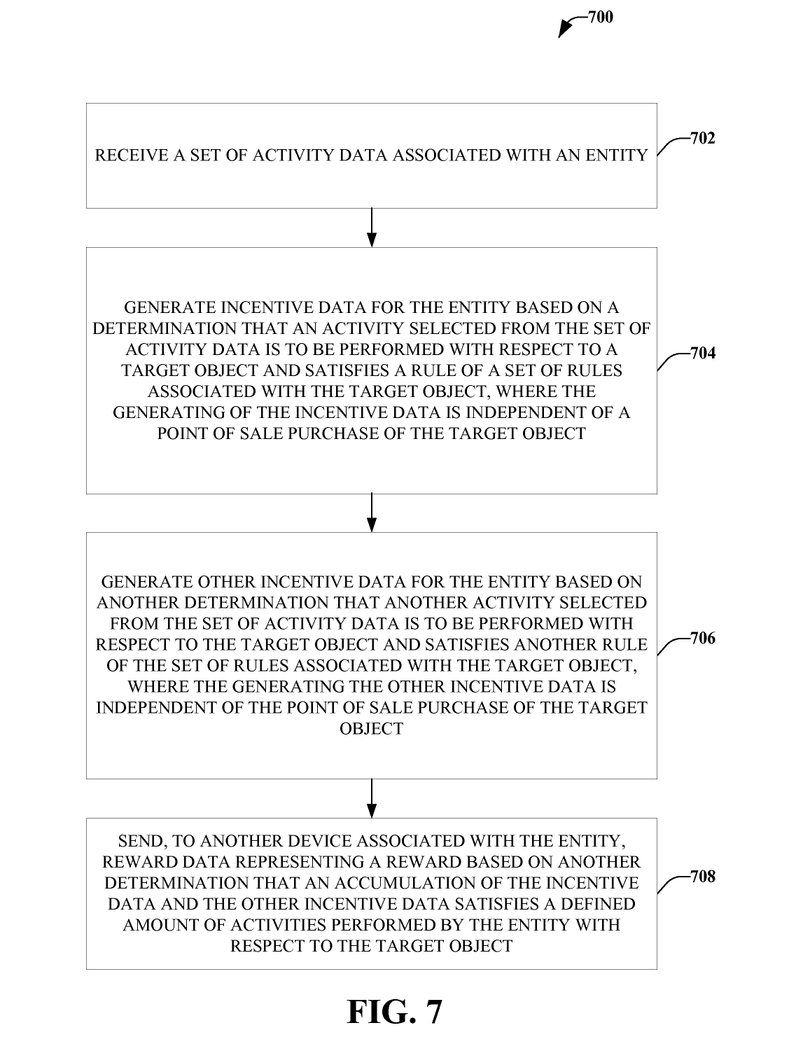

FIG. 7 is a flow diagram illustrating an example, non-limiting embodiment of a method 700 to manage and/or generate incentive data. In an aspect, the method 700 can be associated with a loyalty program system (e.g., a rewards program system). The method 700 in FIG. 7 can be implemented using, for example, any of the systems, such as the system 200 (of FIG. 2), the system 300 (of FIG. 3), the system 400 (of FIG. 4), the system 500 (of FIG. 5), etc., described herein. The method 700 may include one or more operations, functions or actions as illustrated by one or more of blocks 702, 704, 706 and/or 708. In one embodiment, the method 700 can be associated with at least one server (e.g., at least one server 502).

Beginning at block 702, a set of activity data associated with an entity is received. Block 702 may be followed by block 704. At block 704, incentive data for the entity is generated based on a determination that an activity selected from the set of activity data is to be performed with respect to a target object and satisfies a rule of a set of rules associated with the target object, where the generating of the incentive data is independent of a point of sale purchase of the target object. Block 704 may be followed by block 706.

At block 706, other incentive data for the entity is generated based on another determination that another activity selected from the set of activity data is to be performed with respect to the target object and satisfies another rule of the set of rules associated with the target object, where the generating the other incentive data is independent of the point of sale purchase of the target object. For example, other incentive data can be another incentive (e.g., a reward, a discount, etc.) applicable for use (e.g., consumption, etc.) by the entity. In one example, the other incentive data can correspond to the incentive data. In another example, the other incentive data can be different than the incentive data. The other incentive data can be associated with the target object and/or another target object related to the target object. Additionally or alternatively, the other incentive data can be associated with a provider of the other incentive (e.g., a product provider, a service provider, a merchant, a vendor, a company, a corporation, a business, a manufacturer, a retailer, a store, an online store, etc.). Block 706 may be followed by block 708.

At block 708, reward data representing a reward is sent to another device associated with the entity based on another determination that an accumulation of the incentive data and the other incentive data satisfies a defined amount of activities performed by the entity with respect to the target object. For example, reward data representing a reward can be transmitted to a device associated with the entity. In one example, the reward data can be associated with a message transmitted to the device associated with the entity. In another example, the reward data can be associated with a notification displayed on the device associated with the entity and/or can be associated with an application installed on the device associated with the entity. Reward data can be associated with a reward (e.g., a free purchase of the target object or another target object, a discount, etc.) applicable for use (e.g., consumption, etc.) by the entity.

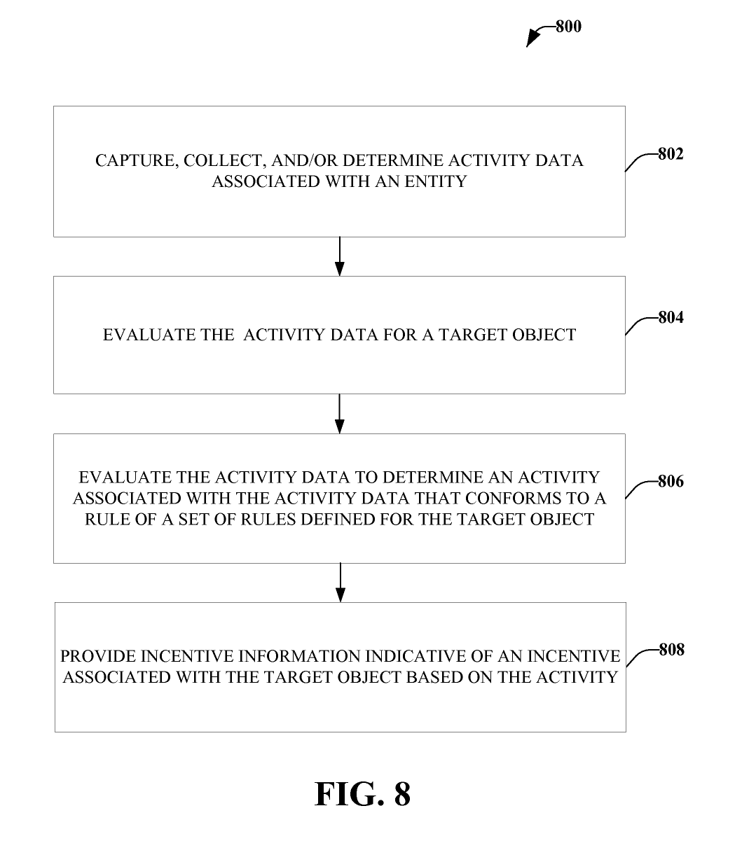

FIG. 8 is a flow diagram illustrating an example, non-limiting embodiment of a method 800 to manage and/or generate incentive data. In an aspect, the method 800 can be associated with a loyalty program system (e.g., a rewards program system). The method 800 in FIG. 8 can be implemented using, for example, any of the systems, such as the system 200 (of FIG. 2), the system 300 (of FIG. 3), the system 400 (of FIG. 4), the system 500 (of FIG. 5), etc., described herein. The method 800 may include one or more operations, functions or actions as illustrated by one or more of blocks 802, 804, 806 and/or 808. In one embodiment, the method 800 can be associated with a device (e.g., device 402) and/or at least one server (e.g., at least one server 502).

Beginning at block 802, activity data associated with an entity is captured, collected, and/or determined. Activity data can correspond to one or more interactions of the entity. In an aspect, activity data associated with a surrounding area related to the entity can be captured via a device associated with the entity. Additionally or alternatively, activity data can be user input provided to the device by the entity. Additionally or alternatively, activity data can be data associated with the device. Activity data can include, but is not limited to, audio data, visual data, sensor data, input data, location data and/or other data associated with the entity and/or the device. Block 802 may be followed by block 804. At block 804, the activity data is evaluated for a target object. For example, a target object associated with the activity data (e.g., audio data, visual data, sensor data, input data, location data and/or other data associated with the entity and/or the device) can be identified. Block 804 may be followed by block 806.

At block 806, the activity data is evaluated to determine an activity associated with the activity data that conforms to a rule of a set of rules defined for the target object. A rule (e.g., a set of rules) can be associated with consumption of the target object, purchase of the target object, recommendation of the target object and/or another interaction with the target object. Additionally, a rule can be associated with a verbal reference related to the target object, a visual reference related to the target object, a location related to the target object, metadata related to the target object, other data related to the target object, etc. Block 806 may be followed by block 808. At block 808, incentive information indicative of an incentive associated with the target object is provided based on the activity. For example, in response to a determination that the activity data is associated with consumption of the target object, purchase of the target object, recommendation of the target object and/or another interaction with the target object, the incentive information (e.g., a reward, discount, etc. applicable for use by the entity) can be generated.

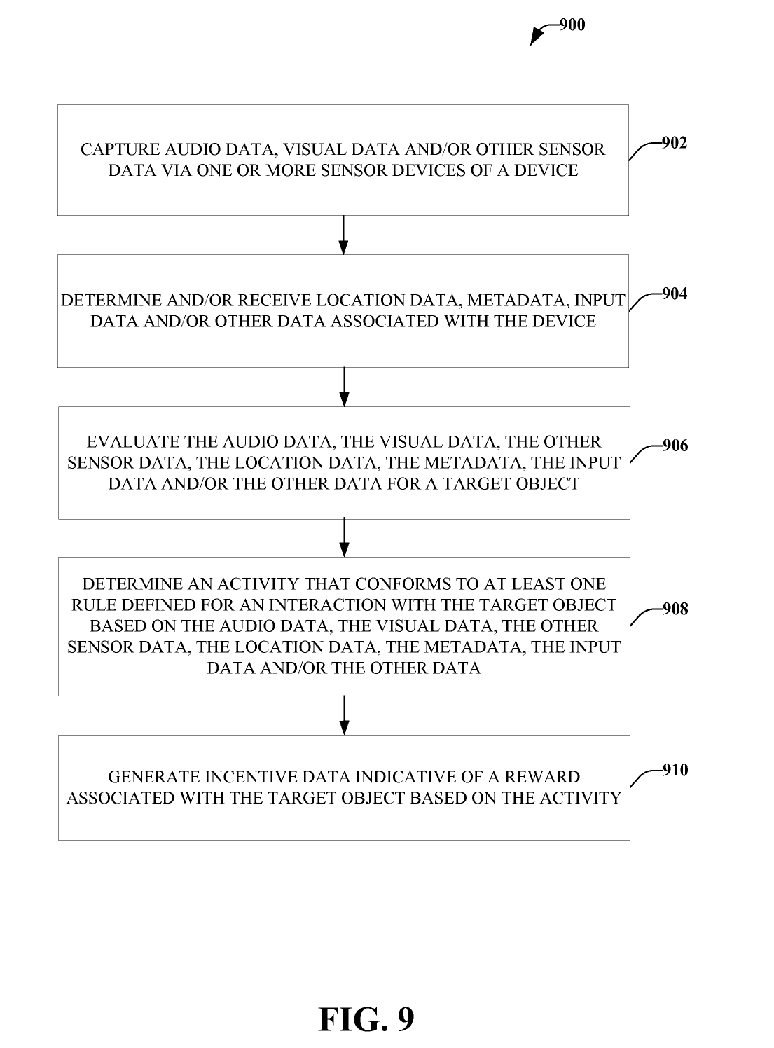

FIG. 9 is a flow diagram illustrating an example, non-limiting embodiment of a method 900 to manage and/or generate incentive data. In an aspect, the method 900 can be associated with a loyalty program system (e.g., a rewards program system). The method 900 in FIG. 9 can be implemented using, for example, any of the systems, such as the system 200 (of FIG. 2), the system 300 (of FIG. 3), the system 400 (of FIG. 4), the system 500 (of FIG. 5), etc., described herein. The method 900 may include one or more operations, functions or actions as illustrated by one or more of blocks 902, 904, 906, 908 and/or 910. In one embodiment, the method 900 can be associated with a device (e.g., device 402) and/or at least one server (e.g., at least one server 502).

Beginning at block 902, audio data, visual data and/or other sensor data are captured via one or more sensor devices of a device. For example, activity data associated with an entity can be captured and/or recorded via a device associated with the entity. The device can include one or more cameras, one or more microphones, one or more 3D imaging systems (e.g., light field sensor(s), motion sensor(s), etc.) and/or other sensory devices to facilitate capturing the audio data, visual data and/or other sensor data. Block 902 may be followed by block 904. At block 904, location data, metadata, input data and/or other data associated with the device are determined and/or received. For example, other activity data associated with the entity and/or the device can be determined and/or received. In one example, the location data and/or the metadata can be stored on the device. In another example, the input data can be user input data presented to the device and/or selected via a screen of the device. Block 904 may be followed by block 906. At block 906, the audio data, the visual data, the other sensor data, the location data, the metadata, the input data and/or the other data are evaluated for a target object. For example, a target object associated with the audio data, the visual data, the other sensor data, the location data, the metadata, the input data and/or the other data can be identified. Block 906 may be followed by block 908.

At block 908, an activity that conforms to at least one rule defined for an interaction with the target object is determined based on the audio data, the visual data, the other sensor data, the location data, the metadata, the input data and/or the other data. For example, an interaction with the target object can include, but is not limited to, consumption of the target object, purchase of the target object, recommendation of the target object and/or another interaction with the target object. Additionally, an interaction with the target device can be associated with a verbal reference related to the target object, a visual reference related to the target object, a location related to the target object, metadata related to the target object and/or other data related to the target object. Block 908 may be followed by block 910. At block 910, incentive data indicative of a reward associated with the target object is generated based on the activity. For example, a reward can be a free purchase of the target object or another target object, a discount, a coupon, a discount code, etc. applicable for use (e.g., consumption, etc.) by the entity.

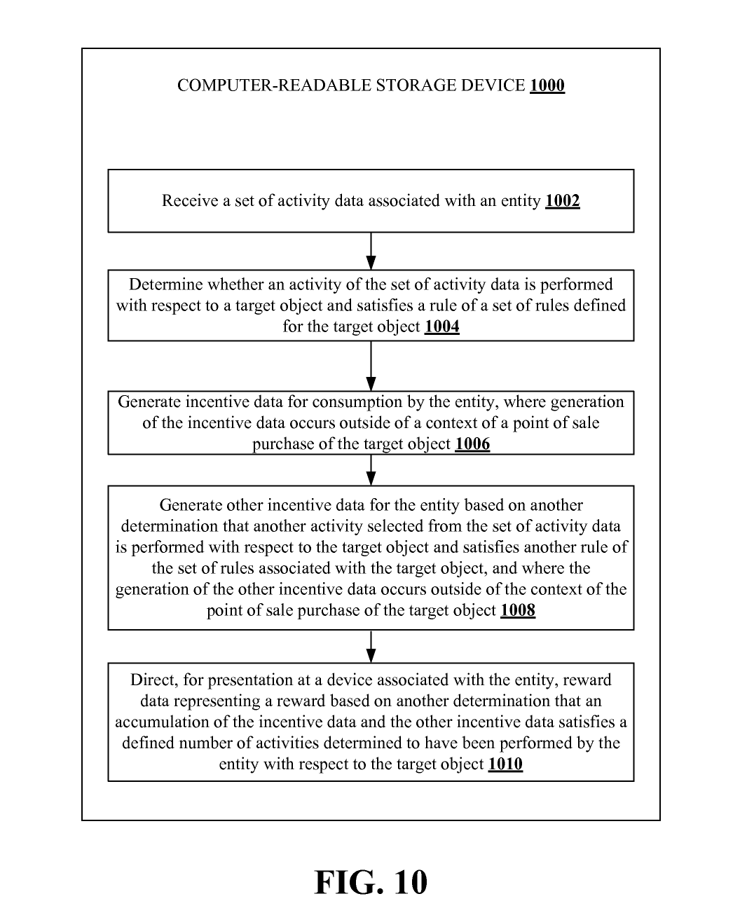

FIG. 10 illustrates a flow diagram of an example, non-limiting embodiment of a set of operations to manage and/or generate incentive data in accordance with at least some aspects of the subject disclosure. The computer-readable storage device 1000 may include executable instructions that, in response to execution, cause a system including a processor to perform the set of operations. The set of operations may include one or more operations, functions or actions as is illustrated by one or more of operations 1002, 1004, 1006, 1008 and/or 1010.

At operation 1002, a set of activity data associated with an entity is received. Operation 1002 may be followed by operation 1004. At operation 1004, it is determined whether an activity of the set of activity data is performed with respect to a target object and satisfies a rule of a set of rules defined for the target object. Operation 1004 may be followed by operation 1006. At operation 1006, incentive data for consumption by the entity is generated, where generation of the incentive data occurs outside of a context of a point of sale purchase of the target object. Operation 1006 may be followed by operation 1008. At operation 1008, other incentive data for the entity is generated based on another determination that another activity selected from the set of activity data is performed with respect to the target object and satisfies another rule of the set of rules associated with the target object, and where the generation of the other incentive data occurs outside of the context of the point of sale purchase of the target object. Operation 1008 may be followed by operation 1010. At operation 1010, reward data representing a reward is directed for presentation at a device associated with the entity based on another determination that an accumulation of the incentive data and the other incentive data satisfies a defined number of activities determined to have been performed by the entity with respect to the target object.

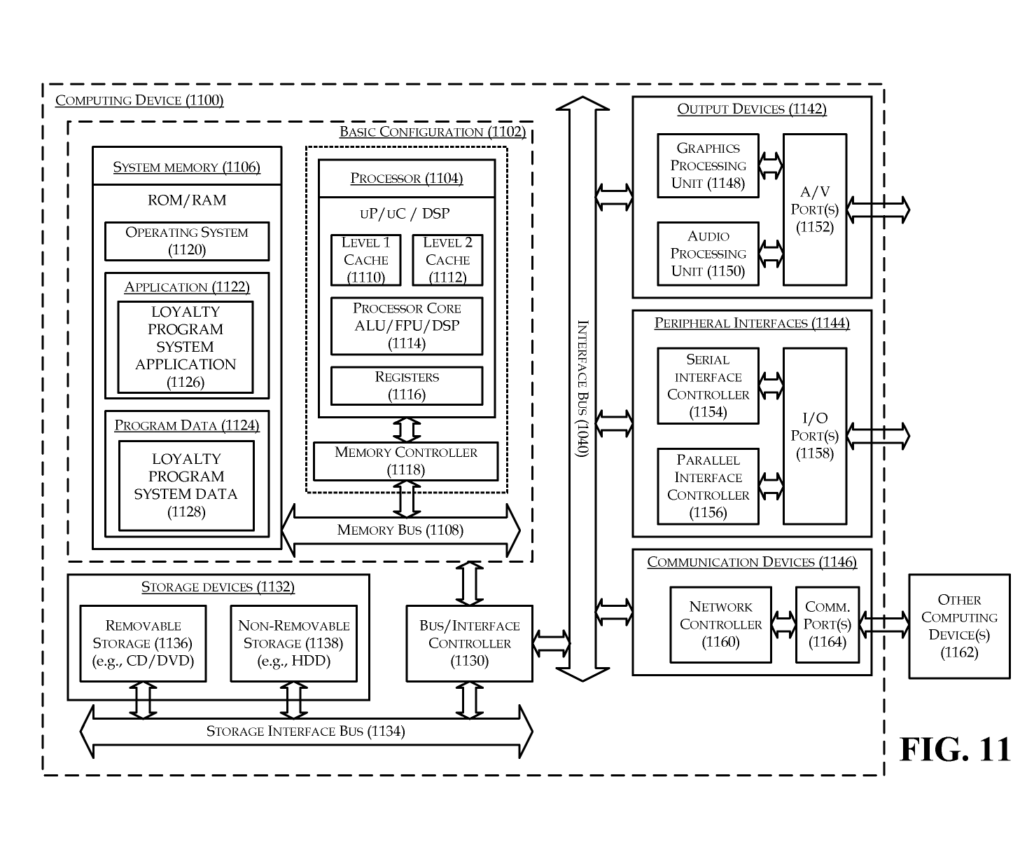

FIG. 11 illustrates an example block diagram of a computing device that is arranged to manage and/or generate incentive data in accordance with one or more embodiments described herein. In a very basic configuration 1102, a computing device 1100 typically includes one or more processors 1104 and a system memory 1106. In some embodiments, the computing device 1100 can be or include the system 200 or the system 300 (or components of the system 200 or the system 300). For example, the computing device 1100 shown in FIG. 11 can be or include structure and/or functionality associated with the activity recognition component 206, the product recognition component 208, the evaluation component 210, the inducement component 212, the documentation component 302 and/or any number of other components/modules/devices described herein. In some embodiments, system memory 1106 may be or include the system 200 or the system 300 (or any components of the system 200 or the system 300). A memory bus 1108 may be used for communicating between a processor 1104 and a system memory 1106.

Depending on the desired configuration, a processor 1104 may be of any type including but not limited to a microprocessor (μP), a microcontroller C), a digital signal processor (DSP), or any combination thereof. Processor 1104 may include one more levels of caching, such as a level one cache 1110 and a level two cache 1112, a processor core 1114, and registers 1116. An example processor core 1114 may include an arithmetic logic unit (ALU), a floating point unit (FPU), a DSP core, or any combination thereof. An example memory controller 1118 may also be used with processor 1104, or in some implementations a memory controller 1118 may be an internal part of processor 1104.

Depending on the desired configuration, system memory 1106 may be of any type including but not limited to volatile memory (such as RAM), non-volatile memory (such as ROM, flash memory, etc.) or any combination thereof. System memory 1106 may include an operating system 1120, one or more applications 1122 (e.g., a loyalty program system application 1126), and program data 1124 (e.g., loyalty program system data 1128). For example, the loyalty program system application 1126 can be or include one or more applications that can cause the computing device 1100 of FIG. 11 to manage and/or generate incentive data associated with the method 100, the system 200, the system 300, the system 400, the system 500, the method 600, the method 700, the method 800 or the method 900, as described herein. Loyalty program system data 1128 can be or include data (e.g., activity data, incentive data, a set of rules, other data, etc.) employed by the method 100, the system 200, the system 300, the system 400, the system 500, the method 600, the method 700, the method 800 or the method 900 to manage and/or generate incentive data associated with the method 100, the system 200, the system 300, the system 400, the system 500, the method 600, the method 700, the method 800 or the method 900, as described herein. In some embodiments, computing device 1100 may be or be included in the system 200 or the system 300 (or one or more components of the system 200 or the system 300). In some embodiments, an application 1122 may be arranged to operate with program data 1124 on an operating system 1120 such that implementations for managing and/or generating incentive data may be performed as described herein. This described basic configuration 1102 is illustrated in FIG. 11 by those components within the inner dashed line.

Computing device 1100 may have additional features or functionality, and additional interfaces to facilitate communications between basic configuration 1102 and any required devices and interfaces. For example, a bus/interface controller 1130 may be used to facilitate communications between basic configuration 1102 and one or more data storage devices 1132 via a storage interface bus 1134. Data storage devices 1132 may be removable storage devices 1136, non-removable storage devices 1138, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

System memory 1106, removable storage devices 1136 and non-removable storage devices 1138 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store the desired information and which may be accessed by computing device 1100. Any such computer storage media may be part of computing device 1100.

Computing device 1100 may also include an interface bus 1140 for facilitating communication from various interface devices (e.g., output devices 1142, peripheral interfaces 1144, and communication devices 1146) to basic configuration 1102 via a bus/interface controller 1130. Example output devices 1142 include a graphics processing unit 1148 and an audio processing unit 1150, which may be configured to communicate to various external devices such as a display or speakers via one or more A/V ports 1152. Example peripheral interfaces 1144 include a serial interface controller 1154 or a parallel interface controller 1156, which may be configured to communicate with external devices such as input devices (e.g., keyboard, mouse, pen, voice input device, touch input device, etc.) or other peripheral devices (e.g., printer, scanner, etc.) via one or more I/O ports 1158. An example communication device 1146 includes a network controller 1160, which may be arranged to facilitate communications with one or more other computing devices 1162 over a network communication link via one or more communication ports 1164.

Computing device 1100 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 1100 may also be implemented as a personal computer including both laptop computer and non-laptop computer configurations.

A network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

The use of hardware or software may be generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples can be implemented, individually and/or collectively, by a wide range of hardware, software, firmware, or virtually any combination thereof. In one embodiment, several portions of the subject matter described herein can be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be possible in light of this disclosure. In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. A typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems. A typical data processing system can be implemented utilizing any suitable commercially available components, such as those typically found in data computing/communication and/or network computing/communication systems.

The herein described subject matter sometimes illustrates different components contained within, or connected with, different other components. Such depicted architectures are merely examples, and many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably coupleable,” to each other to achieve the desired functionality. Specific examples of operably coupleable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations can be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims can contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

The present disclosure is not to be limited in terms of the particular embodiments described in this application, which are intended as illustrations of various aspects. Many modifications and variations can be made without departing from its spirit and scope. Functionally equivalent methods and devices within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. This disclosure is not limited to particular methods, computer-readable storage devices, systems or apparatus disclosed, which can, of course, vary. The terminology used herein is for the purpose of describing particular embodiments only, and is not intended to be limiting.

1. A method, comprising:
receiving, by a device comprising a processor, a set of activity data from another device associated with an entity; and
generating incentive data for the entity associated with the another device based on a determination that an activity selected from the set of activity data is to be performed with respect to a target object and satisfies a rule of a set of rules associated with the target object, wherein the generating the incentive data is independent of a point of sale purchase of the target object.

2. The method of claim 1, further comprising:
generating other incentive data for the entity associated with the another device based on another determination that another activity selected from the set of activity data is to be performed with respect to the target object and satisfies another rule of the set of rules associated with the target object, wherein the generating the other incentive data is independent of the point of sale purchase of the target object.

3. The method of claim 2, further comprising:
sending, to the another device associated with the entity, reward data representing a reward based on another determination that an accumulation of the incentive data and the other incentive data satisfies a defined amount of activities performed by the entity with respect to the target object.

4. The method of claim 1, wherein the receiving the set of activity data comprises recording data related to a set of actions determined to have been performed by the entity with respect to the target object.

5. The method of claim 1, wherein the receiving the set of activity data comprises recording audio data that identifies the target object, and wherein the audio data comprises a specific identification of the target object.

6. The method of claim 1, further comprising recognizing the set of activity data comprising augmenting a scene viewed by the entity with a virtual scene.

7. The method of claim 1, wherein the receiving the set of activity data comprises recording at least a set of activities in which the entity has been determined to have participated.

8. The method of claim 1, further comprising:
transmitting, to the another device associated with the entity, data related to an indication that the incentive data is applicable for use by the entity.

9. The method of claim 1, wherein the receiving the set of activity data comprises:
receiving an instruction to record the set of activity data; and
monitoring the set of activity data for at least one activity that is related to the target object.

10. The method of claim 1, wherein the receiving the set of activity data comprises distinguishing a set of actions determined to have been performed by the entity from another set of actions determined to have been performed by another entity.

11. A system, comprising:
a memory storing executable components; and
a processor, coupled to the memory, operable to execute or facilitate execution of one or more of the executable components, the executable components comprising:
an activity recognition component configured to collect a set of activity information for an entity associated with a device;
a product recognition component configured to evaluate the set of activity information for a target object;
an evaluation component configured to determine an activity of the set of activity information that conforms to a rule of a set of rules defined for the target object; and
an inducement component configured to provide incentive information for the entity associated with the device based on the activity determined by the evaluation component, wherein the incentive information is indicative of an incentive associated with the target object.

12. The system of claim 11, wherein the executable components further comprise a documentation component configured to capture the activity that conforms to the rule at substantially a same time as the activity is performed by the entity.

13. The system of claim 12, wherein the documentation component is configured to record audio information indicative of a verbal reference to the target object by the entity.

14. The system of claim 11, wherein the set of activity information evaluated by the product recognition component comprises at least one of audio information comprising, an identification of the target object or visual information comprising a picture of the target object.

15. The system of claim 11, wherein the evaluation component is configured to determine another activity of the set of activity information that conforms to another rule of the set of rules defined for the target object, and the inducement component is configured to provide other incentive information indicative of another incentive associated with the target object.

16. The system of claim 11, wherein the inducement component is configured to provide reward information that represents a reward based on a determination that an accumulation of a set of incentives that includes the incentive satisfies a defined amount of activities performed by the entity with respect to the target object.

17. The system of claim 11, wherein the device augments a scene viewed by the entity with a virtual scene generated by the device, and wherein the device comprises at least the activity recognition component and the product recognition component.

18. A computer-readable storage device comprising executable instructions that, in response to execution, cause a system comprising a processor to perform operations, comprising:
receiving a set of activity data for an entity associated with a device;
determining whether an activity of the set of activity data is performed with respect to a target object and satisfies a rule of a set of rules defined for the target object; and
generating incentive data for consumption by the entity associated with the device, wherein the generating the incentive data occurs outside of a context of a point of sale purchase of the target object.

19. The computer-readable storage device of claim 18, wherein the operations further comprise:
generating other incentive data for the entity associated with a device based on another determination that another activity selected from the set of activity data is performed with respect to the target object and satisfies another rule of the set of rules associated with the target object, and wherein the generating the other incentive data occurs outside of the context of the point of sale purchase of the target object.

20. The computer-readable storage device of claim 19, wherein the operations further comprise:
directing, for presentation at the device associated with the entity, reward data representing a reward based on another determination that an accumulation of the incentive data and the other incentive data satisfies a defined number of activities determined to have been performed by the entity with respect to the target object.
